(19) United States
(12) Patent Application Publication
(10) Pub. No.: US 2010/0114584 A1
(43) Pub. Date: May 6, 2010

(54) AUDIO DEVICE AND AUDIO PROCESSING METHOD

(76) Inventor: Chung-Hui WENG, Taipei (TW)

Correspondence Address: Muncy, Geissler, Olds & Lowe, PLLC, P.O. BOX 1364, FAIRFAX, VA, 22038-1364, US

(21) Appl. No.: 12/609,972

(22) Filed: Oct. 30, 2009

(30) Foreign Application Priority Data
Nov. 5, 2008 (TW) 97142772

(51) Int. Cl. G10L 19/00

(52) U.S. Cl. 704/500; 704/E19.001

(57) ABSTRACT

An audio device and an audio processing method are provided. The audio device includes a digital microphone module and an audio codec. The digital microphone module captures an external audio source according to a spread-spectrum clock, in order to generate a digital audio source signal. The audio codec includes a clock generation module, a storage unit, and an audio codec core. The clock generation module generates a clock signal and the spread-spectrum clock. The storage unit temporarily stores a first digital audio source signal from the digital microphone module according to the spread-spectrum clock, and outputs the first digital audio source signal according to the clock signal. The audio codec core comprises a digital-to-analog (D/A) converter and an analog-to-digital (A/D) converter.

### CROSS-REFERENCES TO RELATED APPLICATIONS

This non-provisional application claims priority under 35 U.S.C. §119(a) on Patent Application No. 97142772 filed in Taiwan, R.O.C. on Nov. 5, 2008, the entire contents of which are hereby incorporated by reference.

### BACKGROUND

1. Technical Field

The disclosure relates to an audio device and an audio processing method, and more particularly to an audio device and an audio processing method designed for a digital microphone.

2. Related Art

Computers, including desktops, notebooks, and laptop computers, and mobile phones both have a sound effect processing function, and are generally provided with a sound effect codec serving as a sound effect processing unit. The sound effect codec is usually connected to an output device and an input device. The output device includes a speaker or an earphone, and the input device includes an analog microphone, a digital microphone, or a Line In.

A conventional microphone is easily interfered with by noise, such as the dial tone of a mobile phone, and more interference sources will be generated if a printed circuit board (PCB) trace is lengthened. Therefore, a digital microphone was proposed. As signals from the digital microphone are transmitted in the form of digital data, noises do not easily interfere with a digital microphone.

When the digital microphone is applied to a computer or mobile phone as an audio input device, the sound effect codec provides a clock signal required by the digital microphone, and the digital microphone captures an audio source signal according to the clock signal and provides the audio source signal to the sound effect codec.

As the clock signal provided by the sound effect codec is a high-frequency signal, and the digital microphone is typically disposed at a certain distance from the sound effect codec in practical applications, a longer wire may act like an antenna to radiate a high-frequency component in the clock signal, resulting in an interference with an electronic device, i.e., causing an electromagnetic interference (EMI).

### SUMMARY

Accordingly, the disclosure is directed to an audio device and an audio processing method, so as to eliminate the problems of the digital microphone in practical applications. By means of the device and method provided by the disclosure, the electromagnetic interference (EMI) generated by the high-frequency clock signal in the prior art can be reduced, thus reducing the danger of exposure of electromagnetic waves to the human body.

An audio codec is provided, which includes a clock generation module, a storage unit, and an audio codec core. The clock generation module generates a clock signal and a spread-spectrum clock. The storage unit temporarily stores a first digital audio source signal from a digital microphone module according to the spread-spectrum clock, and outputs the first digital audio source signal according to the clock signal. The audio codec core has a digital-to-analog (D/A) converter and an analog-to-digital (A/D) converter. The A/D converter converts a first analog audio source signal into a second digital audio source signal, and the D/A converter converts a third digital audio source signal into a second analog audio source signal for broadcasting.

An audio processing method is further provided. The method includes: generating a spread-spectrum clock according to a clock signal; temporarily storing a digital audio source signal from a digital microphone module in a storage unit according to the spread-spectrum clock; reading the digital audio source signal stored in the storage unit according to the clock signal; and outputting the digital audio source signal through a digital interface circuit.

An audio codec is further provided, which includes an audio codec core, a clock generator, a spread-spectrum circuit, a storage element, a filter, and an interface unit. The audio codec core performs signal conversions on a first audio source signal and a second audio source signal. The clock generator generates a clock signal. The spread-spectrum circuit spreads the clock signal, and outputs a spread-spectrum clock. The storage element receives a digital audio source signal from a digital microphone according to the spread-spectrum clock, and outputs the digital audio source signal according to the clock signal. The filter performs at least one of a down-conversion and a low-pass filtering on the digital audio source signal, and generates a filtered digital audio source signal. The interface unit outputs the filtered digital audio source signal and the first audio source signal from the audio codec core to a host, and receives the second audio source signal from the host to the audio codec core.

Preferred embodiments of the disclosure and efficacies thereof are illustrated in detail below with reference to the accompanying drawings.

### BRIEF DESCRIPTION OF THE DRAWINGS

The disclosure will become more fully understood from the detailed description given herein below for illustration only, and thus not limitative of the disclosure, wherein:

FIG. 1 is a schematic view of an audio device according to an embodiment of the disclosure;

FIG. 2 is a schematic view of time sequences of digital microphones and a spread-spectrum clock according to an embodiment;

FIG. 3 is a schematic view of a spread spectrum of a clock signal; and

FIG. 4 is a flow chart of an audio processing method according to the disclosure.

### DETAILED DESCRIPTION

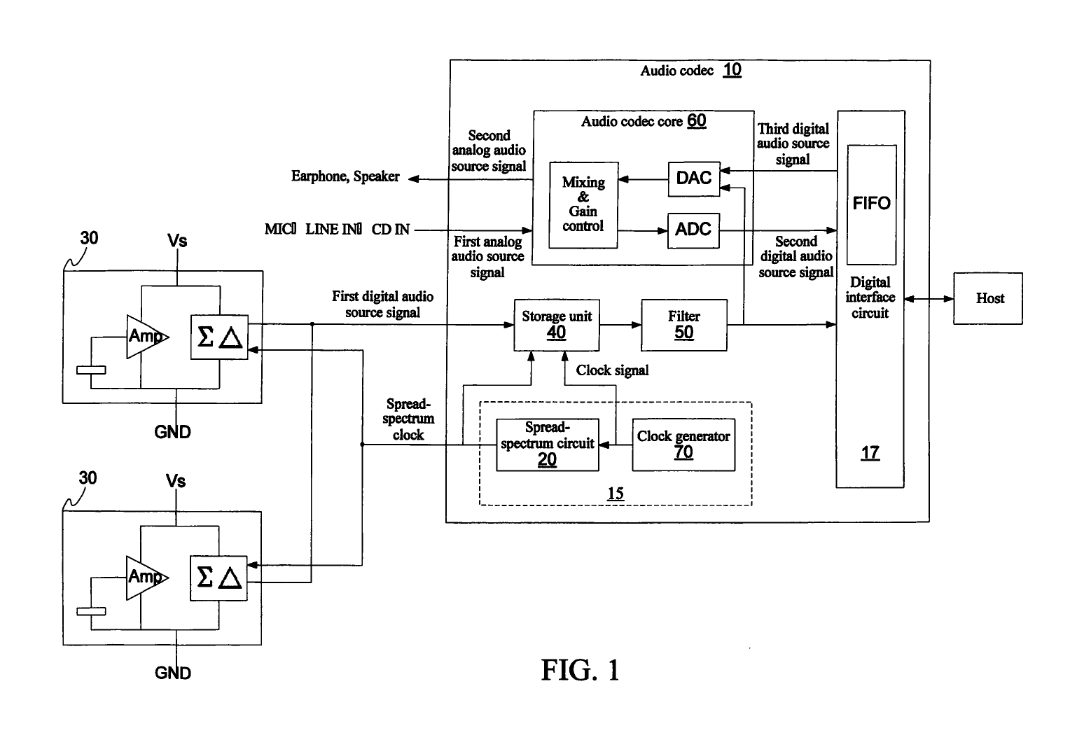

FIG. 1 is a schematic view of an audio device according to an embodiment of the disclosure. Referring to FIG. 1, the audio device of the embodiment includes an audio codec 10 and a digital microphone module 30. The audio codec 10 includes an audio codec core 60, a digital interface circuit 17, a clock generation module 15, and a storage unit 40. The audio codec core 60 is known to those of ordinary skill in the art, so the details thereof will not be described herein again. The digital interface circuit 17 supports specifications of a high definition audio (HDA) interface or an AC-link interface.

The clock generation module 15 generates a clock signal and a spread-spectrum clock. The digital microphone module 30 captures an external audio according to the spread-spectrum clock in order to generate a digital audio source signal, and transmits the digital audio source signal to the audio codec 10.

In this case the spread-spectrum clock is dynamically changed (time-varying), i.e., the clock frequency is sometimes fast and sometimes slow. Accordingly, the digital audio source signal returned by the digital microphone module 30 is also sometimes fast and sometimes slow, resulting in an asynchronicity problem. In order to solve the asynchronicity problem, the audio codec 10 includes the storage unit 40. The storage unit 40 may be a first-in-first-out (FIFO) buffer for storing the digital audio source signal from the digital microphone module 30, so as to prevent data from being lost if it fails to be processed in time due to the asynchronicity problem. Further, the audio codec 10 includes a filter 50, for performing a down-conversion and/or low-pass filtering on the digital audio source signal, so as to enable the filtered digital audio source signal to meet specifications of the digital interface circuit 17.

In an embodiment, the filtered digital audio source signal is fed to the audio codec core 60, and the audio codec core 60 performs a D/A conversion on the filtered digital audio source signal to generate an analog audio source signal for broadcasting.

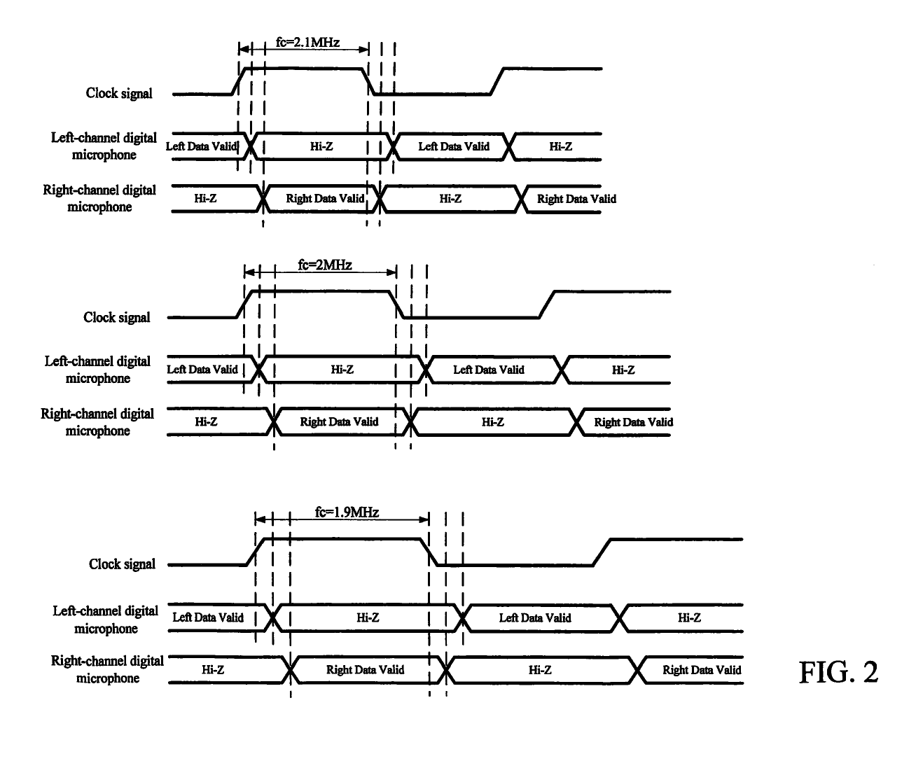

In an embodiment, after receiving the spread-spectrum clock the digital microphone module 30 captures an audio source signal amplified by an amplifier (Amp) in the digital microphone module 30 by means of a rising edge and a falling edge in the spread-spectrum clock. A detailed timing diagram is shown in FIG. 2, which is a schematic view of time sequences of digital microphones and a spread-spectrum clock according to an embodiment.

In an embodiment, the digital microphone module 30 may include a left-channel digital microphone and a right-channel digital microphone, and definitely may also only use a single-channel microphone, so the disclosure is not limited thereto. In FIGS. 1 and 2, two digital microphone modules 30 are provided as an example for illustration, including a left-channel digital microphone and a right-channel digital microphone. Still referring to FIG. 2, it should be noted that, the left and right-channel digital microphones do not capture audio source signals at the same time, but instead, the other digital microphone captures an audio source signal only when one of the two digital microphones is in a high impedance state. In this way, audio source signals on the left and right channels are captured.

When the digital microphone module 30 detects that the spread-spectrum clock is at a rising edge, the left-channel digital microphone is switched to a high impedance (Hi-Z) state first, and then the right-channel digital microphone is switched from a Hi-Z state to a state capable of capturing an audio source signal (i.e., a data valid state), after a short period of time (usually several nanoseconds (ns)). In this case, the audio codec 10 captures the audio source signal of the left-channel digital microphone first when the spread-spectrum clock is at the rising edge and before the left-channel digital microphone is switched to the Hi-Z state.

In another aspect, when the digital microphone module 30 detects that the spread-spectrum clock is at a falling edge, the right-channel digital microphone is switched to a Hi-Z state first, and likewise the left-channel digital microphone is then switched from a Hi-Z state to a data valid state after a short period of time. Likewise, the audio codec 10 captures the audio source signal of the right-channel digital microphone when the spread-spectrum clock is at the falling edge and before the right-channel digital microphone is switched to the Hi-Z state.

A frequency range of the audio source signal is from 20 Hz to 20 KHz, which is a range of sound frequencies audible to the human ear. Moreover, a frequency range of the spread-spectrum clock may be from 1 MHz to 4 MHz, which is a range of frequencies receivable by the digital microphone module 30. Therefore, the disclosure proposes to distribute the frequencies of the spread-spectrum clock within one range, so as to reduce the EMI.

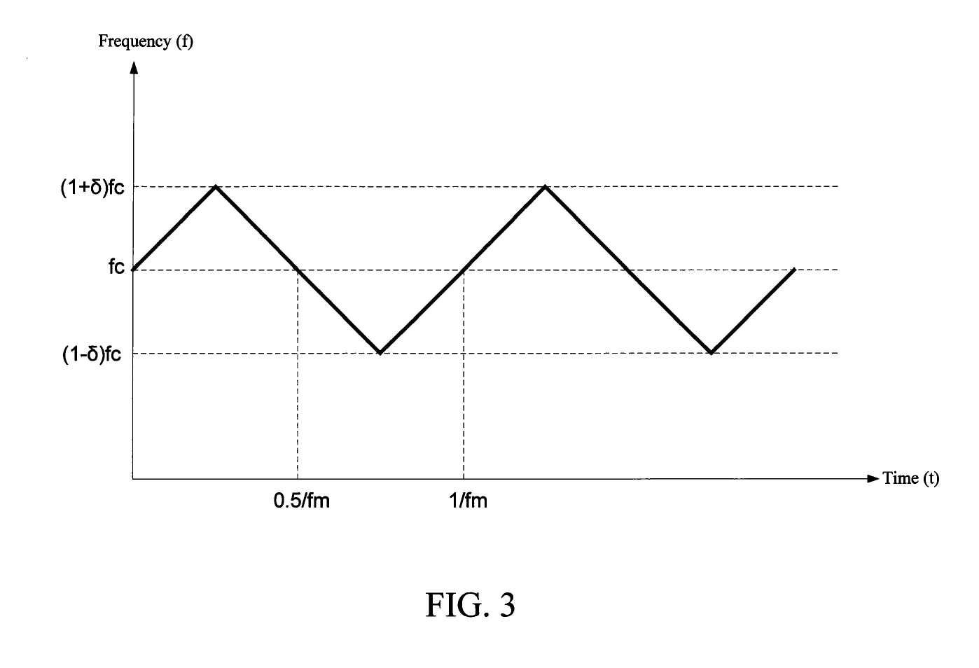

FIG. 3 is a schematic view of a spread spectrum of a clock signal. The spread-spectrum clock generated by the spread-spectrum circuit 20 with a spread-spectrum function has a frequency varying with time. Taking the audio device as an example, since the frequency range of the clock signal is from 1 MHz to 4 MHz, it is assumed that a center frequency fc of the clock signal is 2 MHz. According to the spread-spectrum circuit 20 of the embodiment, the EMI can be reduced by means of an up-spread or down-spread technique. Taking the up-spread technique as an example, the center frequency fc may be increased to (1+δ)*fc, in which δ is referred to as a spread rate in the embodiment. If the spread rate (δ) is 5%, i.e., a spread amplitude is 0.1 MHz (2 MHz*5%), the center frequency fc is increased to 2.1 MHz from an original 2 MHz.

Taking the down-spread technique for example, the center frequency fc may be decreased to (1−δ)*fc. Likewise, if the spread rate (δ) is 5%, the spread amplitude is also 0.1 MHz, and thus the center frequency fc is decreased to 1.9 MHz from an original 2 MHz. In this case the spread rate may be in a range of ±0.5% to ±5%. Moreover, the spread rate is in inverse proportion to EMI generated by the audio device. That is to say, the larger the spread rate is, the smaller the EMI will be. The EMI can thus be reduced by increasing the spread rate.

It can be seen from FIG. 3 that a parameter fm is configured on the time axis, and the parameter fm represents a modulation rate. 1/fm is a time period of the spread-spectrum clock, and within one time period (1/fm), a spread-spectrum clock having a maximum frequency (for example, 2.1 MHz), and a spread-spectrum clock having a minimum frequency (for example, 1.9 MHz), are generated once, respectively. As the frequency range of the audio source signal of the embodiment is audible to the human ear, i.e., from 20 Hz to 20 KHz, it is found from experimental data that if a single-frequency audio source signal is input and a modulation rate (fm) thereof is lower than 40 KHz, inter modulation distortion (IMD) will be caused at a frequency of 20 Hz to 20 KHz after the spread-spectrum operation, which can be expressed by an equation: IMD signal=fm−audio source signal. As a result, a user may hear other noises, and the audio quality is affected. Therefore, the modulation rate (fm) of the spread-spectrum circuit 20 of the embodiment may be in a range of 40 KHz to 50 KHz, so that no distorted signal is generated in the frequency range recognizable by the human ear after the spread-spectrum operation. Of course, the frequency range of the modulation rate may also be adjusted according to actual requirements.

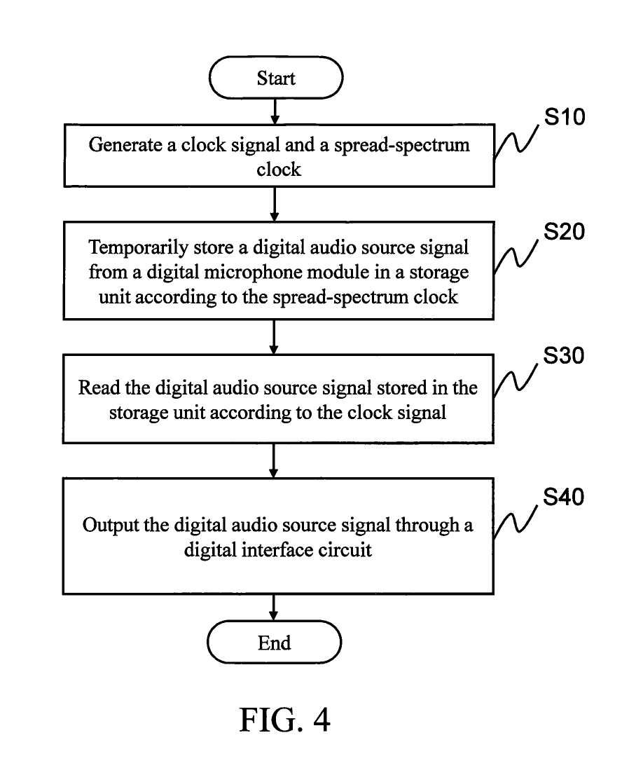

FIG. 4 is a flow chart of an audio processing method according to the embodiment. Referring to FIG. 4, the method includes the following steps.

In Step S10, a clock signal and a spread-spectrum clock are generated. A frequency range of the clock signal is from 1 MHz to 4 MHz.

In an embodiment, the digital microphone module captures an external audio to generate a digital audio source signal according to the spread-spectrum clock. In an embodiment, the digital microphone module includes a left-channel digital microphone and a right-channel digital microphone. For a modulation rate of the spread-spectrum clock, a frequency may be selected from a range of 40 KHz to 50 KHz for performing the spread-spectrum operation. Moreover, a spread rate of the spread-spectrum clock is in inverse proportion to an EMI generated by the audio processing method. In this case the spread rate may be in a range of ±0.5% to ±5%.

In Step S20, the digital audio source signal from the digital microphone module is stored temporarily in a storage unit according to the spread-spectrum clock. The storage unit may be a FIFO buffer.

In Step S30, the digital audio source signal stored in the storage unit is read according to the clock signal.

In Step S40, the digital audio source signal is output through a digital interface circuit. In an embodiment, the digital interface circuit may be an HDA interface or an AC-link interface.

In addition to the above steps, the method further includes: performing a down-conversion and/or low-pass filtering on the digital audio source signal.

While the disclosure has been described by the way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. An audio codec, comprising:
a clock generation module, for generating a clock signal and a spread-spectrum clock;
a storage unit, for storing temporarily a first digital audio source signal from a digital microphone module according to the spread-spectrum clock, and outputting the first digital audio source signal according to the clock signal; and
an audio codec core, coupled to the storage unit, comprising a digital-to-analog (D/A) converter and an analog-to-digital (A/D) converter, wherein the A/D converter converts a first analog audio source signal into a second digital audio source signal, and the D/A converter converts a third digital audio source signal into a second analog audio source signal for broadcasting.

2. The audio codec according to claim 1, wherein the clock generation module comprises:
a clock generator, for generating the clock signal; and
a spread-spectrum circuit, for spreading the clock signal, and outputting the spread-spectrum clock.

3. The audio codec according to claim 1, wherein a modulation rate of the spread-spectrum clock ranges from no lower than 40 KHz to no greater than 50 KHz.

4. The audio codec according to claim 1, wherein a spread rate of the spread-spectrum clock is in a range of ±0.5% to ±5%.

5. The audio codec according to claim 1, wherein a frequency of the clock signal ranges from no lower than 1 MHz to no greater than 4 MHz.

6. The audio codec according to claim 1, further comprising:
a filter, coupled to the audio codec core and the storage unit, for performing at least one of a down-conversion and a low-pass filtering on the first digital audio source signal, and generating a filtered first digital audio source signal.

7. The audio codec according to claim 6, further comprising:
a digital interface circuit, coupled to the audio codec core and the filter, for transmitting at least one of the filtered first digital audio source signal and the second digital audio source signal to a host, and transmitting the third digital audio source signal from the host to the audio codec core.

8. The audio codec according to claim 7, wherein the digital interface circuit supports at least one of an AC-link interface and a high definition audio (HDA) interface.

9. The audio codec according to claim 6, wherein the D/A converter converts the filtered first digital audio source signal for broadcasting.

10. An audio processing method, comprising:
generating a spread-spectrum clock according to a clock signal;
storing temporarily a digital audio source signal from a digital microphone module in a storage unit according to the spread-spectrum clock;
reading the digital audio source signal stored in the storage unit according to the clock signal; and
outputting the digital audio source signal through a digital interface circuit.

11. The audio processing method according to claim 10, wherein a modulation rate of the spread-spectrum clock ranges from no lower than 40 KHz to no greater than 50 KHz.

12. The audio processing method according to claim 10, wherein a spread rate of the spread-spectrum clock is in a range of ±0.5% to ±5%.

13. The audio processing method according to claim 10, wherein the digital interface circuit supports at least one of an AC-link interface and a high definition audio (HDA) interface.

14. The audio processing method according to claim 10, wherein a frequency of the clock signal ranges from no lower than 1 MHz to no greater than 4 MHz.

15. The audio processing method according to claim 10, further comprising:
performing at least one of a down-conversion and a low-pass filtering on the digital audio source signal.

16. The audio processing method according to claim 10, wherein the digital microphone module comprises a left-channel digital microphone and a right-channel digital microphone.

17. An audio codec, comprising:
a clock generator, for generating a clock signal;
a spread-spectrum circuit, for spreading the clock signal, and outputting a spread-spectrum clock;
a storage element, for receiving a digital audio source signal from a digital microphone according to the spread-spectrum clock, and outputting the digital audio source signal according to the clock signal;
a filter, for performing at least one of a down-conversion and a low-pass filtering on the digital audio source signal, and generating a filtered digital audio source signal;
an audio codec core, coupled to the filter, for performing signal conversions on a first audio source signal and a second audio source signal; and
an interface unit, coupled to the filter and the audio codec core, for outputting the filtered digital audio source signal from the filter and the first audio source signal from the audio codec core to a host, and receiving the second audio source signal from the host to the audio codec core.

18. The audio codec according to claim 17, wherein a modulation rate of the spread-spectrum circuit ranges from no lower than 40 KHz to no greater than 50 KHz.

19. The audio codec according to claim 17, wherein a spread rate of the spread-spectrum circuit is in a range of ±0.5% to ±5%.

20. The audio codec according to claim 17, wherein the interface unit supports at least one of an AC-link interface and a high definition audio (HDA) interface.
